(19) United States
(12) Patent Application Publication
(10) Pub. No.: US 2026/0274620 A1
(43) Pub. Date: Sep. 17, 2026

(54) CRANE ASSEMBLY FOR A FORESTRY VEHICLE

(71) Applicant: DEERE & COMPANY, MOLINE, IL (US)

(72) Inventor: PEKKA VESANEN, Tampere (FI)

(21) Appl. No.: 19/554,740

(22) Filed: Mar. 3, 2026

(30) Foreign Application Priority Data
Mar. 11, 2025 (EP) 25162962.2

(51) Int. Cl. B66C 23/42; A01G 23/00; A01G 23/08; B66C 23/70

(52) U.S. Cl. CPC B66C 23/42; A01G 23/003; A01G 23/08; B66C 23/702; B66C 2700/0371

(57) ABSTRACT

The disclosed system for a work vehicle is adapted to realize a movement of a boom assembly during a feed process of the work vehicle. The vehicle comprises a boom assembly having a slewing device, a boom tip having a rotator and an extension boom. The boom assembly is adapted to rotate a connected working device around a vertical axis, wherein the working device is a harvester tool. The system controlling the boom assembly comprises movement of the stem through the harvester tool during feeding over the ground and is at least partly compensated by movement of the boom tip, wherein the movement is in a direction of a longitudinal axis of the stem.

### CROSS REFERENCE TO RELATED APPLICATIONS

This application claims priority under 35 U.S.C. § 119 to European patent application EP 25162962, filed on Mar. 11 2025, the disclosure of which is incorporated herein by reference.

### FIELD OF THE DISCLOSURE

The present disclosure generally relates to a crane assembly for a forestry vehicle, in particular, a forwarder or a harvester.

### BACKGROUND OF THE DISCLOSURE

Forestry vehicles, such as forwarders or harvesters, are equipped with tools for handling trees or tree trunk utilizing a grapple head or a harvesting head. The tool is mounted on the outer end of a crane assembly. The crane assembly is supported on the chassis of the vehicle on a turntable, allowing rotation about a vertical axis and enabling movement of the tool in both vertical and horizontal directions.

One example of a crane assembly is disclosed in WO 02/45482 A1. In that arrangement, a support base is mounted on a turntable. A proximal end of a first boom is pivotally coupled to the support base about a first horizontal axis. A pivot arm is also pivoted about this same axis. The angular position of the pivot arm about the first axis, and thus relative to the horizontal plane, is controlled by a first linear actuator, such as a hydraulic cylinder, coupled between the support base and the pivot arm. A second linear actuator is coupled between the pivot arm and the first boom, approximately at a central region of the first boom. A second boom is pivotally coupled to a distal end of the first boom about a second axis that extends parallel to the first axis. The second boom directly or indirectly supports the tool at its distal end. The second boom may be telescopic or may carry a telescoping jib, at the distal end of which the tool is mounted.

A linkage arrangement includes an elongated arm having a proximal end pivotally coupled to the pivot arm and a distal end pivotally coupled to the second boom by a first connecting arm. A second connecting arm is pivotally coupled to both the first connecting arm and the first boom. This linkage arrangement enables pivoting of the second boom about the second axis by actuation of the second linear actuator, while simultaneously changing the angular position of the first boom about the first axis. All of the pivot axes described above are parallel to one another.

In the embodiment shown in WO 02/45482 A1, the housing of the first linear actuator is coupled to the support base and the actuator rod is coupled to the pivot arm. In contrast, in some forestry vehicles, the housing of the first linear actuator is connected to the pivot arm and the rod is connected to the support base, such that the actuator is mounted above the pivot arm rather than between the pivot arm and the support base as shown in WO 02/45482 A1.

EP 2 116 128 A1 discloses another forestry vehicle having two boom arms arranged in a parallelogram configuration, with an upper portion of the parallelogram formed by a third boom that supports the tool. An actuator for moving the boom arms relative to one another is pivotally coupled to the front boom arm near its central region and to the rear boom arm at a pivot point of a strut that connects the lower ends of the two boom arms. A lift cylinder for the parallelogram-mounted booms is also pivotally connected at this same location.

In the prior art disclosed in WO 02/45482 A1, the elongated arm and the first linear actuator are pivotally connected to the pivot arm at different locations, with the pivot point of the first linear actuator positioned closer to the first axis than the pivot point of the elongated arm. This configuration makes it possible to use a linear actuator with a relatively short stroke, but necessitates the use of multiple, separate pivot joints. Consequently, the prior art crane assembly is comparatively complex. This same drawback is also present in the aforementioned current forestry vehicles in which the first linear actuator is mounted above the pivot arm even though the parallelogram arrangement disclosed in EP 2 116 128 A1 differs substantially in its overall structural configuration from the boom assembly of WO 02/45482 A1.

Therein lies an opportunity to overcome or at least reduce one or more of the disadvantages disclosed above.

### SUMMARY OF THE DISCLOSURE

Various aspects of the present disclosure are set out in the claims.

According to the present disclosure, A vehicle comprises a chassis supported by a ground engaging means and a crane assembly supported by the chassis. The crane assembly includes a support base, a first boom, a pivot arm, a first linear actuator, a second linear actuator, a second boom, and a linkage. The support base is mounted on a turntable which is rotatable around a vertical axis. The first boom pivoted at its proximal end around a first, horizontal axis on the support base. The pivot arm pivots around the first axis on the support base. The first linear actuator is coupled between the support base and the pivot arm, and adapted to control an inclination of the pivot arm around the first axis. The second linear actuator is coupled between the pivot arm and the first boom. The second boom is pivoted at the distal end of the first boom around a second axis extending parallel to the first axis wherein the second boom is adapted to support a tool at its distal end.

The linkage with an elongated arm has a proximal end that pivots around a third axis on the pivot arm and a distal end pivotally connected by a first connecting arm to the second boom and a second connecting arm pivoted to the first connecting arm and to the first boom. The linkage is adapted to pivot the second boom around the second axis by actuation of the second linear actuator.

The first linear actuator is pivotally supported on the third axis.

The second boom is telescopable. The first linear actuator has a housing coupled to the third pivot axis and a moveable output element coupled to the support base.

The housing of the first linear actuator is fixed to an elongate support ring supported around the third axis on the pivot arm.

The pivot arm is composed of two parts on both sides of the longitudinal symmetry plane of the crane assembly, while the support ring holding the housing of the first linear actuator is supported by the third pivot axis on the inner sides of the pivot arm.

The pin of the pivot joint making up the third pivot axis supports the elongated arm and the support ring. The vehicle may either be a forwarder or harvester.

Other features and aspects will become apparent by consideration of the detailed description and accompanying drawings.

### BRIEF DESCRIPTION OF THE DRAWINGS

FIG. 1 is a schematical view of vehicle in the form of a forestry harvester with a crane assembly.

FIG. 2 is a side view of the crane assembly of the vehicle of FIG. 1, and

FIG. 3 is a perspective view of the crane assembly of FIG. 2.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments may include any combination of features from one or more dependent claims, and such features may be incorporated, collectively or separately, into any independent claim.

### DETAILED DESCRIPTION

The present embodiment concern work vehicle for a forestry application with a harvester tool for felling and processing stems or logs, and method.

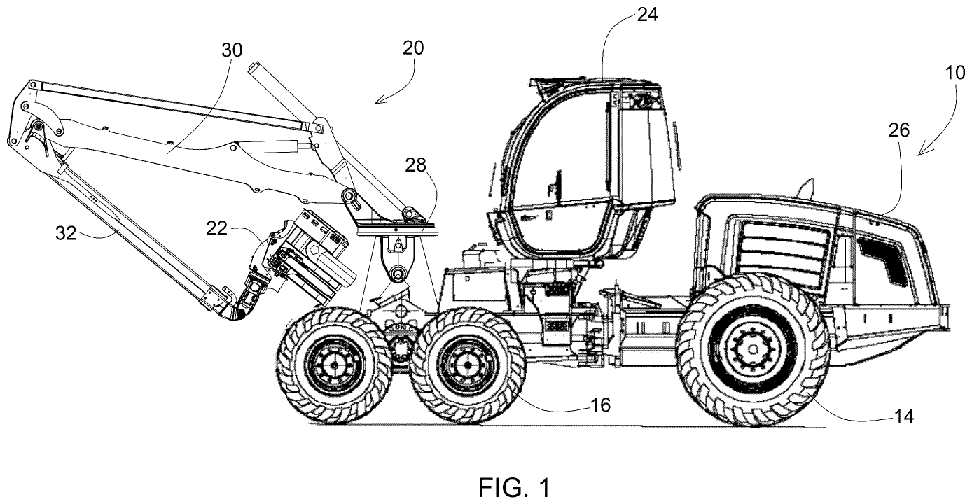

FIG. 1 illustrates an off-road vehicle 10. The off-road vehicle 10 includes an articulated chassis 12 supported on ground-engaging means in the form of driven front wheels 14 and rear wheels 16. The chassis 12 supports a crane assembly 20, at a distal end of which a tool 22, shown in the form of a harvester head, is mounted. The chassis 12 further supports an operator cabin 24 and an engine compartment 26 containing an engine for supplying mechanical, electrical, and/or hydraulic power to driven components of the vehicle 10. The crane assembly 20 may also be used on a forwarder for forestry applications.

The crane assembly 20 comprises a lower part 30 having a proximal end that is rotatably mounted on the chassis 12 about a vertical axis by a turntable 28, and an upper part 32 in the form of a telescoping boom or jib.

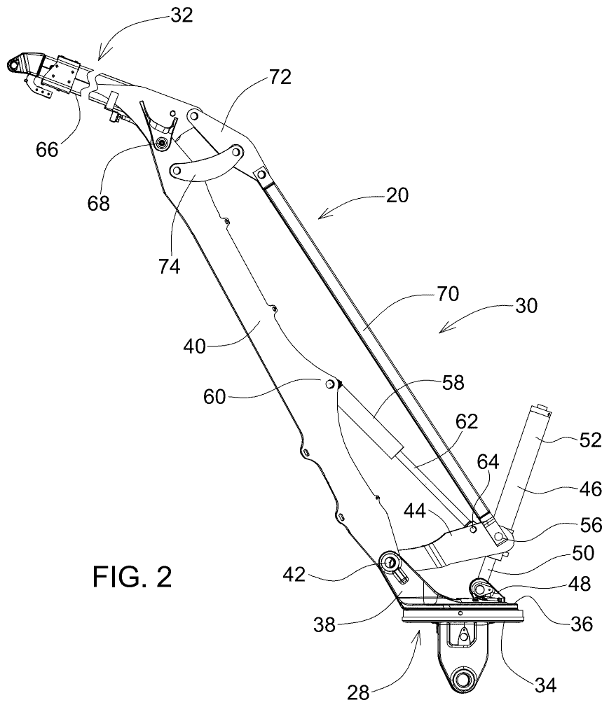

Reference is now made to FIG. 2, which shows the crane assembly 20 in greater detail. The turntable 28 includes a lower part 34 mounted to the chassis 12 and an upper part 36 that is rotatable about a vertical axis relative to the lower part 34 by an actuator (not shown). A flange-like, upright support base 38 is mounted on the upper part 36. A first boom 40 is pivotally connected at its proximal end about a first horizontal axis 42 on the support base 38. A second boom 66 is pivotally connected at a distal end of the first boom 40 about a second axis 68 extending parallel to the first axis 42. The second boom 66 is configured to support the tool 22 at its distal end. In the illustrated embodiment, the second boom 66 is telescopable by an actuator (not shown).

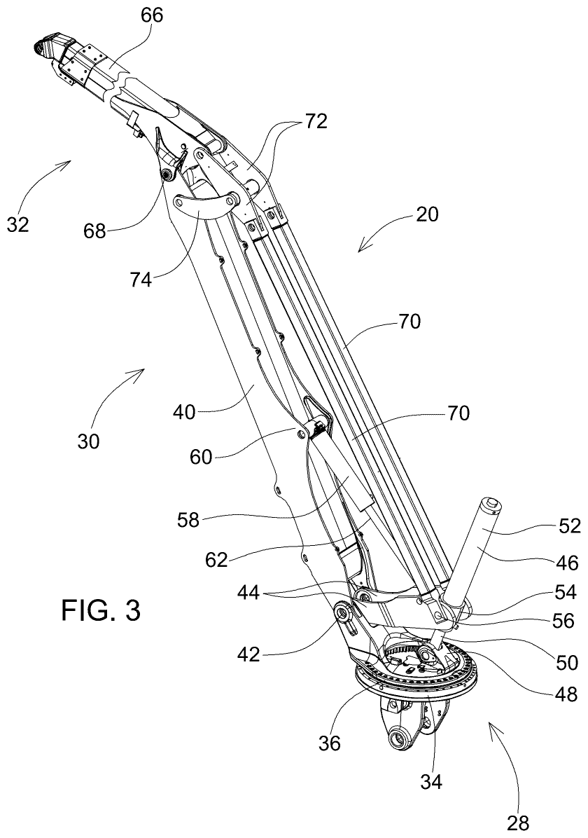

A pivot arm 44 is also pivotally connected to the support base 38 about the first axis 42. A first linear actuator 46, in the form of a hydraulic cylinder, is pivotally coupled by its movable output element 50 (rod) to a bracket 48 that is mounted, either directly or via the upper part 36 of the turntable 28, to the support base 38. A housing 52 of the first linear actuator 46 is fixed to an elongated support ring 54 (see FIG. 3), which is pivotally supported at its end about a third axis 56 on the pivot arm 44. The first linear actuator 46 is thus configured to control inclination of the pivot arm 44 about the first axis 42.

A second linear actuator 58, also in the form of a hydraulic cylinder, is coupled between the pivot arm 44 and the first boom 40. In the illustrated embodiment, a housing of the second linear actuator 58 is pivotally connected to a protruding portion 60 of the first boom 40, and a movable output element 62 of the second linear actuator 58 is pivotally connected to the pivot arm 44 about an axis 64. The axis 64 is located in the vicinity of the third axis 56, but is offset therefrom in a vertical direction and toward the first boom 40.

A linkage arrangement includes an elongated arm 70 having a proximal end pivotally connected about the third axis 56 on the pivot arm 44 and a distal end pivotally connected to the second boom 66 by a first connecting arm 72. A second connecting arm 74 is pivotally connected to both the first connecting arm 72 and the first boom 40. Both connecting arms 72 and 74 are pivotable at their respective ends. The linkage arrangement is configured to pivot the second boom 66 about the second axis 68 upon actuation of the second linear actuator 58, while simultaneously changing an angular position of the first boom 40 about the first axis 42.

All of the pivot axes described above, except for the rotation axis of the turntable 28, are parallel to one another and extend transversely to the plane of the drawing in FIG. 2.

As described above, the first linear actuator 46 and the elongated arm 70 are pivotally connected to the pivot arm 44 about the same third pivot axis 56. As shown in FIG. 3, two elongated arms 70 and two sets of connecting arms 72, 74 are provided on opposite sides of a longitudinal symmetry plane of the lower part 30 of the crane assembly 20. The connecting arms 72 may be formed as separate components or as a unitary structure, for example as a welded assembly including a transverse connection between the two connecting arms 72 illustrated. The elongated arms 70 are supported on the third axis 56 on outer sides of the pivot arm 44, which itself comprises two parts arranged on opposite sides of the longitudinal symmetry plane of the lower part 30 of the crane assembly 20. The support ring 54 carrying the housing 52 of the first linear actuator 46 is supported by the third pivot axis 56 on inner sides of the pivot arm 44. Accordingly, a single pivot pin defining the third pivot axis 56 simultaneously supports both an elongated arm 70 and the support ring 54.

What is claimed is:

1. A crane assembly comprising:
a support base mounted on a turntable which is rotatable around a vertical axis;
a first boom pivoted at its proximal end around a first, horizontal axis on the support base;
a pivot arm pivoted around the first axis on the support base;
a first linear actuator coupled between the support base and the pivot arm, adapted to control an inclination of the pivot arm around the first axis;
a second linear actuator coupled between the pivot arm and the first boom;
a second boom pivoted at the distal end of the first boom around a second axis extending parallel to the first axis wherein the second boom is adapted to support a tool at its distal end;
a linkage with an elongated arm having a proximal end pivoted around a third axis on the pivot arm and a distal end pivotally connected by a first connecting arm to the second boom and a second connecting arm pivoted to the first connecting arm and to the first boom, the linkage adapted to pivot the second boom around the second axis by actuation of the second linear actuator,
wherein the first linear actuator is pivotally supported on the third axis.

2. The crane assembly of claim 1, wherein the second boom is telescopable.

3. The crane assembly of claim 1, wherein the first linear actuator has a housing coupled to the third pivot axis and a movable output element coupled to the support base.

4. The crane assembly of claim 3, wherein the housing of the first linear actuator is fixed to an elongate support ring pivotally supported around the third axis on the pivot arm.

5. The crane assembly of claim 4, wherein the pivot arm is composed of two parts on both sides of the longitudinal symmetry plane of the crane assembly, while the support ring holding the housing of the first linear actuator is supported by the third pivot axis on the inner sides of the parts of the pivot arm.

6. The crane assembly of claim 5, wherein two elongated arm, two first connecting arms and two second connecting arm are provided on both sides of the longitudinal symmetry plane of the crane assembly and the elongated arms are supported on the third axis on the outsides of the parts of the pivot arm.

7. The crane assembly of claim 6, wherein the pin of the pivot joint making up the third pivot axis supports the elongated arm and the support ring.

8. A vehicle comprising:
a chassis supported by a ground engaging means;
a crane assembly supported by the chassis, the crane assembly including
a support base mounted on a turntable which is rotatable around a vertical axis;
a first boom pivoted at its proximal end around a first, horizontal axis on the support base;
a pivot arm pivoted around the first axis on the support base;
a first linear actuator coupled between the support base and the pivot arm, adapted to control an inclination of the pivot around the first axis;
a second linear actuator coupled between the pivot arm and the first boom;
a second boom pivoted at the distal end of the first boom around a second axis extending parallel to the first axis wherein the second boom is adapted to support a tool at its distal end;
a linkage with an elongated arm having a proximal end pivoted around a third axis on the pivot arm and a distal end pivotally connected by a first connecting arm to the second boom and a second connecting arm pivoted to the first connecting arm and to the first boom, the linkage adapted to pivot the second boom around the second axis by actuation of the second linear actuator,
wherein the first linear actuator is pivotally supported on the third axis.

9. The vehicle of claim 8, wherein the second boom is telescopable.

10. The vehicle of claim 8, wherein the first linear actuator has a housing coupled to the third pivot axis and a moveable output element coupled to the support base.

11. The crane assembly of claim 10, wherein the housing of the first linear actuator is fixed to an elongate support ring supported around the third axis on the pivot arm.

12. The crane assembly of claim 11, wherein the pivot arm is composed of two parts on both sides of the longitudinal symmetry plane of the crane assembly, while the support ring holding the housing of the first linear actuator is supported by the third pivot axis on the inner sides of the pivot arm.

13. The crane assembly of claim 12, wherein the pin of the pivot joint making up the third pivot axis supports the elongated arm and the support ring.

14. The vehicle of claim 8, wherein the vehicle is one of a forwarder and a harvester.
